(19) United States
(12) Patent Application Publication
(10) Pub. No.: US 2013/0003499 A1
(43) Pub. Date: Jan. 3, 2013

(54) INTERFEROMETRIC METHOD OF ENHANCING PASSIVE SEISMIC EVENTS

(75) Inventor: ABDULLATIF A. AL-SHUHAIL, DHAHRAN (SA)

(73) Assignees: KING ABDULAZIZ CITY FOR SCIENCE AND TECHNOLOGY, RIYADH (SA); KING FAHD UNIVERSITY OF PETROLEUM AND MINERALS, DHAHRAN (SA)

(21) Appl. No.: 13/171,196

(22) Filed: Jun. 28, 2011

(51) Int. Cl. G01V 1/36

(52) U.S. Cl. 367/50

(57) ABSTRACT

The interferometric method of enhancing passive seismic events includes the step of cross-correlation (CC) of the trace recorded at a reference receiver location with the traces recorded at the rest of receiver locations. Next, the CC traces are aligned to zero timing by applying shifts that are calculated by searching for the position of the maximum CC trace value. Subsequently, the aligned CC traces are summed to produce a stacked CC trace that has a signal-to-noise ratio (SNR) better than the individual CC traces. Lastly, the stacked CC trace is convolved with each raw trace to put the MS event at the correct timing. Due to this process, the timing of the MS event on the i-th convolved trace, tccasci, will be equal to the timing of the MS event on the corresponding i-th raw trace, i.e., tccasci=ti.

### BACKGROUND OF THE INVENTION

1. Field of the Invention

The present invention relates generally to passive seismic event detection, and particularly to an interferometric method of enhancing passive seismic events that provides an algorithm for correlating multiple seismic traces to enhance detection of weak passive seismic events.

2. Description of the Related Art

Seismic interferometry involves the cross-correlation of responses at different receivers to obtain the Green's function between these receivers. For the simple situation of an impulsive plane wave propagating along the x-axis, the cross-correlation of the responses at two receivers along the x-axis gives the Green's function of the direct wave between these receivers.

When the source function of the plane wave is a transient, as in exploration seismology, or a noise signal, as in passive seismology, then the cross-correlation gives the Green's function convolved with the autocorrelation of the source function.

Direct-wave interferometry also holds for 2-D and 3-D situations, assuming the receivers are surrounded by a uniform distribution of sources. Seismic interferometry (SI) involves cross-correlation (CC) and summation of traces. SI has been used in many applications. Enhancement of weak microseismic (MS) events has, however, remained problematic.

Thus, an interferometric method of enhancing passive seismic events solving the aforementioned problem is desired.

### SUMMARY OF THE INVENTION

The interferometric method of enhancing passive seismic events uses an algorithm that employs SI to enhance weak microseismic (MS) events. The interferometric method includes the step of cross-correlation (CC) of the trace recorded at a reference receiver location with the traces recorded at the rest of receiver locations. If the source wavelet recorded at all receivers is constant, then these CC traces should be very similar to each other, except for a time shift due to different receiver locations. Due to this process, the timing of a micro-seismic (MS) event on the i-th CC trace is given as: tcci=ti-tr, where tr and ti are the timings of the MS event on the raw reference and i-th traces. If the first receiver (i=1) is selected as the reference receiver; then i runs from 2 to M, where M is the total number of receivers in the experiment.

Next, the CC traces are aligned to zero timing by applying shifts that are calculated by searching for the position of the maximum CC trace value. Due to this process, the timing of the MS event on the aligned i-th CC trace (tccai) will be zero, regardless of the receiver location (i.e., tccai=0).

Subsequently, the aligned CC traces are summed to produce a stacked CC trace that has a signal-to-noise ratio (SNR) better than the individual CC traces. Note that the timing of the MS event (tccas) will also be zero on this stacked CC trace (i.e., tccas=0).

Lastly, the stacked CC trace is convolved with each raw trace to put the MS event at the correct timing. Due to this process, the timing of the MS event on the i-th convolved trace (tccasci) will be equal to the timing of the MS event on the corresponding i-th raw trace (i.e., tccasci=ti).

These and other features of the present invention will become readily apparent upon further review of the following specification and drawings.

### BRIEF DESCRIPTION OF THE DRAWINGS

FIG. 1 is a plot of a source wavelet with no noise.

FIG. 2 is a plot of a source wavelet with noise.

FIG. 3 is a plot of receiver coordinates and source coordinates.

FIG. 4 is a plot of normalized raw traces.

FIG. 5 is a plot of a cross-correlation of each trace with respect to the first trace.

FIG. 6 is a plot of aligned cross-correlation traces.

FIG. 7 is a plot of a stacked cross-correlation trace.

FIG. 8 is a plot of convolved cross-correlation traces.

Similar reference characters denote corresponding features consistently throughout the attached drawings.

### DETAILED DESCRIPTION OF THE PREFERRED EMBODIMENTS

The interferometric method of enhancing passive seismic events includes cross-correlation of the trace recorded at a reference receiver location with the traces recorded at the rest of receiver locations. If the source wavelet recorded at all receivers is constant; then these CC traces should be very similar to each other, except for a time shift due to different receiver locations. Due to this process, the timing of a MS event on the i-th CC trace is given as,

tcci=ti−tr (1)

where tr and ti are the timings of the MS event on the raw reference and i-th traces. If the first receiver (I=1) is selected as the reference receiver; then i runs from 2 to M, where M is the total number of receivers in the experiment.

Next, the CC traces are aligned to zero timing by applying shifts that are calculated by searching for the position of the maximum CC trace value. Due to this process, the timing of the MS event on the aligned i-th CC trace, tccai, will be zero, regardless of the receiver location, i.e., tccai=0.

Subsequently, the aligned CC traces are summed to produce a stacked CC trace that has a signal-to-noise ratio (SNR) better than the individual CC traces. Note that the timing of the MS event (tccas) will also be zero on this stacked CC trace (i.e., tccas=0).

Lastly, the stacked CC trace is convolved with each raw trace to put the MS event at the correct timing. Due to this process, the timing of the MS event on the i-th convolved trace, tccasci, will be equal to the timing of the MS event on the corresponding i-th raw trace i.e., tccasci=ti.

It will be understood that the diagrams in the Figures depicting the interferometric method for enhancing passive microseismic (MS) are exemplary only, and that the interferometric method may be embodied in a dedicated electronic device having a microprocessor, microcontroller, digital signal processor, application specific integrated circuit, field programmable gate array, any combination of the aforementioned devices, or other device that combines the functionality of the interferometric method for enhancing passive microseismic (MS) onto a single chip or multiple chips programmed to carry out the method steps described herein, or may be embodied in a general purpose computer having the appropriate peripherals attached thereto and software stored on a computer readable media that can be loaded into main memory and executed by a processing unit to carry out the functionality of the apparatus and steps of the method described herein.

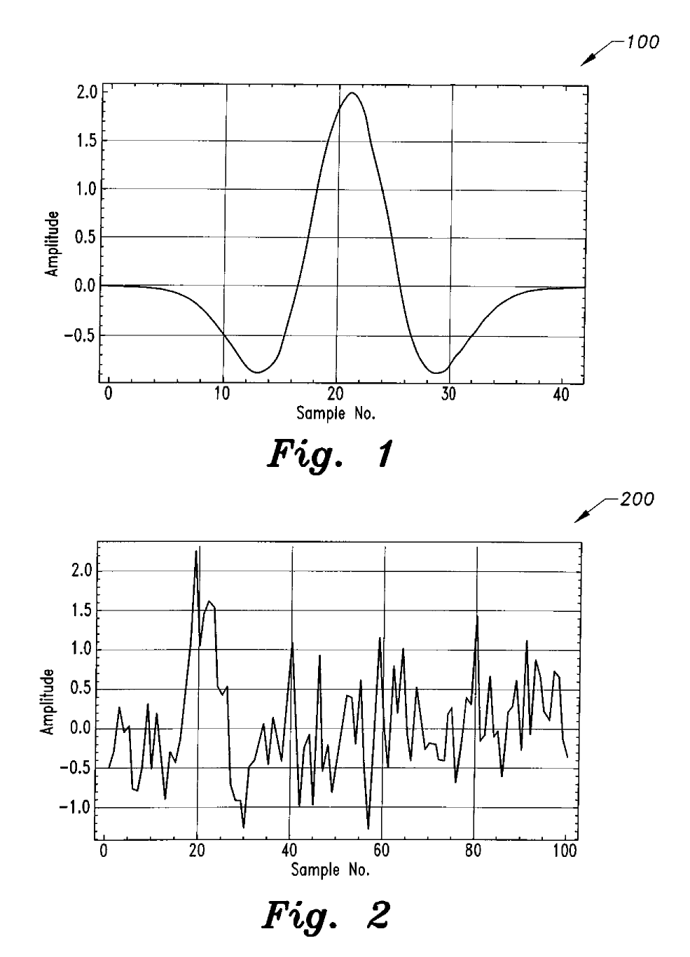

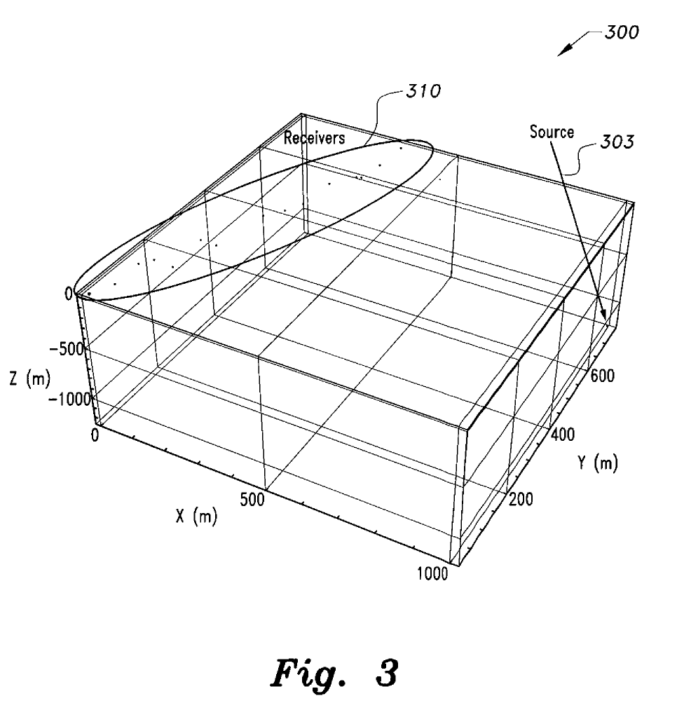

As an example, the method steps implementing the interferometric algorithm described herein is applied to synthetic seismic data generated using the following parameters: Referring to FIGS. 1 and 2, the source wavelet is a 5-Hz zero-phase Ricker wavelet 100 with a peak amplitude of 2, to which one hundred samples of Gaussian random noise with zero mean and 0.5 standard deviation to obtain the wave 200 shown in FIG. 2 to simulate the effects of ambient noise. The sampling interval is 10 ms with three hundred samples per trace. The coarse values of these parameters are only used to facilitate algorithm testing, but actual values will be used when applying the algorithm on real data. The exemplary source coordinates are {xs=1000, ys=750, zs=−1250} meters. As shown in FIG. 3, fifteen receivers 310 are located on the ground surface with coordinates as follows. The reference receiver is the first receiver (closest to the source) with coordinates of {xr1=0, yr1=0, zr1=0} meters. Coordinates of the i-th receiver are found as {xri=xr1+i*dxr±R[dxr], yri=yr1+i*dyr±R[dyr], zri=0}, where {dxr=25, dyr=50} meters, R[dxr] means a random integer between ±dxr, R[dyr] means a random integer between ±dyr, and i runs from 2 to 15. The medium velocity is constant at 2000 m/s.

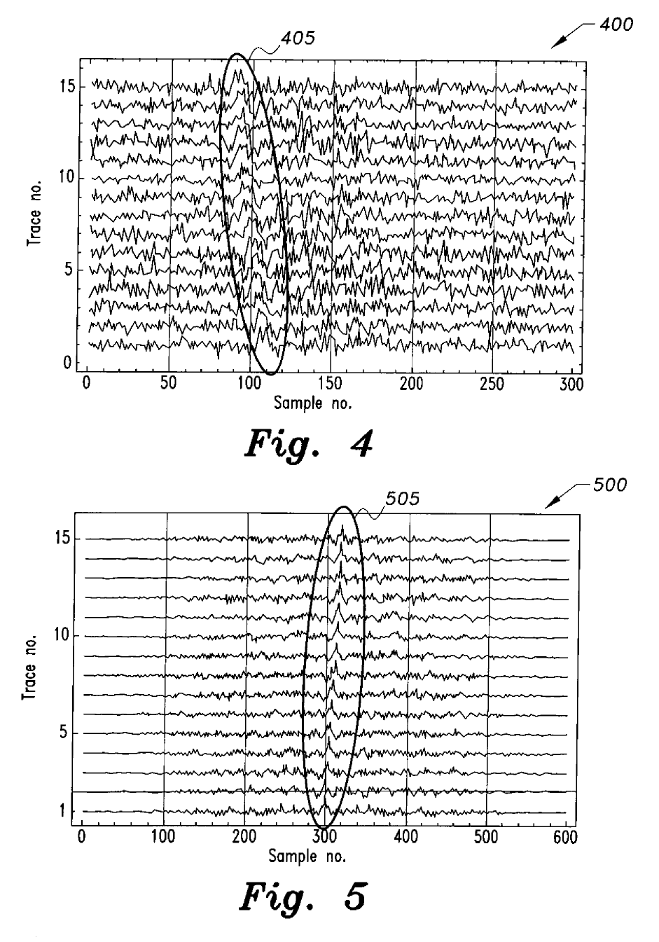

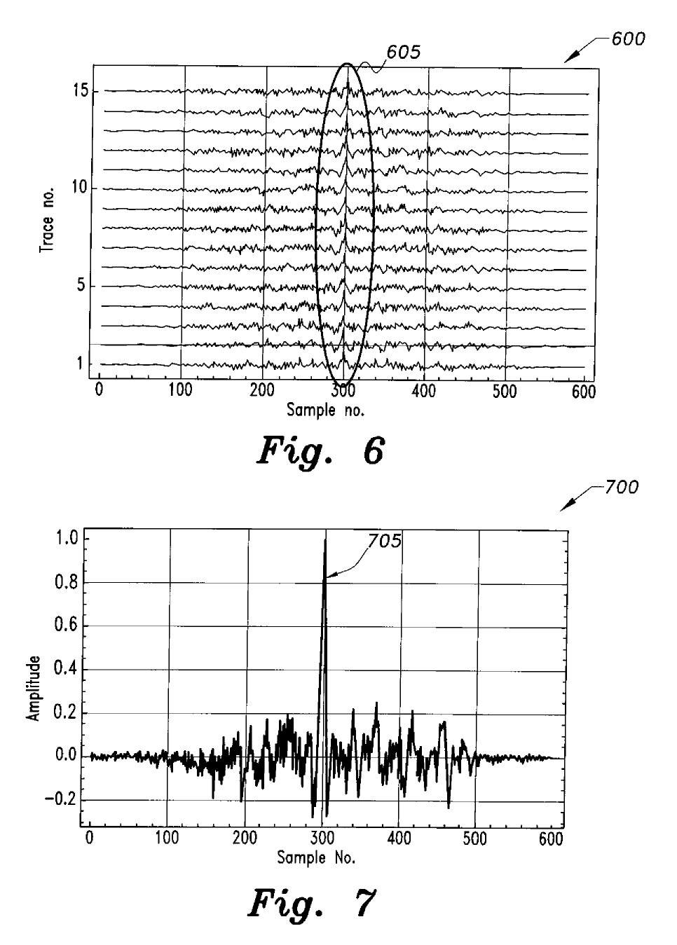

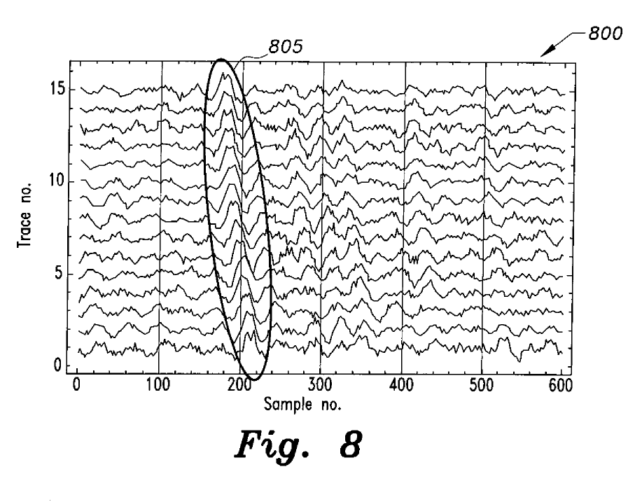

The raw traces are generated by ray tracing. Plot 400 of FIG. 4 shows the traces after normalizing each trace by its maximum value. Note the difficulty in picking the normalized trace MS event 405. Plot 500 of FIG. 5 shows the cross-correlation (CC) traces 505. The MS event is easier to spot, but not time-aligned. Plot 600 of FIG. 6 shows the aligned CC traces 605. Plot 700 of FIG. 7 shows the stacked CC trace 705. Plot 800 of FIG. 8 shows the convolved traces 805. Comparison of FIGS. 4 and 8 shows clear SNR enhancement in the convolved traces 805 over the raw traces 405, which facilitates picking up the MS event considerably.

The algorithm can be enhanced by using all possible trace pairs for cross-correlation. The maximum number of CC traces generated from M receivers is M². If this is done, the SNR of the convolved traces could be as much as M times the SNR of the raw traces. This approach is expected to be operational on synthetic data, as well as real data acquired in field testing.

It is to be understood that the present invention is not limited to the embodiments described above, but encompasses any and all embodiments within the scope of the following claims.

I claim:

1. An interferometric method of enhancing passive microseismic (MS) events, comprising the steps of:
cross-correlating a trace recorded at a reference receiver location with raw traces recorded at other receiver locations to form cross-correlated (CC) traces;
aligning the CC traces to zero timing, thereby forming aligned CC traces;
summing the aligned CC traces, thereby producing a stacked CC trace having a signal-to-noise ratio better than the CC traces taken individually; and
convolving the stacked CC trace with each of the raw traces, thereby putting the MS event at a correct timing.

2. The interferometric method of enhancing passive seismic events according to claim 1, further comprising the step of using all possible trace pairs for cross-correlation.

3. An interferometric system for enhancing passive microseismic (MS) events, comprising:
a plurality of seismic event receivers, the plurality including a reference seismic event receiver disposed at a location adapted for recording of a microseismic event source;
means for cross-correlating a trace recorded at the reference receiver location with raw traces recorded at locations of the other receivers in the plurality of receivers to form cross-correlated (CC) traces;
means for aligning the CC traces to zero timing, thereby forming aligned CC traces;
means for summing the aligned CC traces, thereby producing a stacked CC trace having a signal-to-noise ratio better than the CC traces taken individually; and
means for convolving the stacked CC trace with each of the raw traces, thereby putting the MS event at a correct timing.

4. The interferometric system of enhancing passive seismic events according to claim 3, further comprising means for using all possible trace pairs for cross-correlation.

5. A computer software product, comprising a medium readable by a processor, the medium having stored thereon a set of instructions for enhancing passive microseismic (MS) events, the set of instructions including:
(a) a first sequence of instructions which, when executed by the processor, causes said processor to cross-correlate a trace recorded at a reference receiver location with raw traces recorded by receivers at other receiver locations to form cross-correlated (CC) traces;
(b) a second sequence of instructions which, when executed by the processor, causes said processor to align the CC traces to zero timing, thereby forming aligned CC traces;
(c) a third sequence of instructions which, when executed by the processor, causes said processor to sum the aligned CC traces, thereby producing a stacked CC trace having a signal-to-noise ratio better than the CC traces taken individually; and
(d) a fourth sequence of instructions which, when executed by the processor, causes said processor to convolve the stacked CC trace with each of the raw traces, thereby putting the MS event at a correct timing.

6. The computer software product according to claim 5, further comprising a fifth sequence of instructions which, when executed by the processor, causes said processor to use all possible trace pairs for cross-correlation.
